(19) United States
(12) Patent Application Publication
(10) Pub. No.: US 2002/0148580 A1
(43) Pub. Date: Oct. 17, 2002

(54) Coating apparatus and coated-paper manufacturing method

(76) Inventors: Masahiro Sugihara, Hiroshima-ken (JP); Hiroshi Miura, Hiroshima-ken (JP); Kenji Yamada, Hiroshima-ken (JP); Seiji Machida, Saitama-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/073,253

(22) Filed: Feb. 13, 2002

(30) Foreign Application Priority Data
Feb. 13, 2001 (JP) 2001-36052

(51) Int. Cl. D21H 19/00; B05C 1/08; B05C 3/12

(52) U.S. Cl. 162/135; 162/265; 118/244; 118/419; 118/407

(57) ABSTRACT

A coating layer, which has the property of releasing a coated liquid, is formed on the outer peripheral surface of a cylindrical rod. The rod is engaged with a first roll, and rotates in a predetermined direction. A coating liquid is supplied to a nip surface portion between the first roll and the rod in the predetermined direction, and a film of coating liquid is formed on the outer peripheral surface of the first roll. After the thickness of the coating-liquid film is adjusted at the nip surface portion, the thickness-adjusted film is transferred from the first roll onto a surface of the base paper directly, or indirectly through the second roll.

### TECHNICAL FIELD

The present invention relates to a coating apparatus, equipped in a papermaking machine, for applying a coating liquid to the surface of base paper traveling continuously, and more particularly to a rod metaling type coating apparatus and a coated-paper manufacturing method employing the coating apparatus.

### BACKGROUND ART

Conventional paper making machines are equipped with a coating apparatus for applying a coating liquid to the surface of base paper to enhance the beauty of paper and the printing quality. Coating apparatuses are generally divided into a blade type and a rod metaling type according to methods of adjusting the thickness of a film of coating liquid.

FIG. 5 shows the construction of a conventional rod metaling type coating apparatus. As shown in the figure, the coating apparatus is equipped with a pair of applicator rolls 2, 2 across a conveying line for base paper 1 that travels continuously. The applicator rolls 2, 2 nip the base paper 1 at the nip surface portion therebetween, and feed the base paper 1 in one direction by rotating synchronously at a peripheral speed equal to the paper feeding speed in the directions indicated by arrows in FIG. 5.

Coating liquid supply heads 3, 3 are provided near the applicator rolls 2, 2 to supply a coating liquid to the surfaces of the applicator rolls 2, 2. Each liquid supply head 3 is equipped with a rod 4, which is disposed parallel to the applicator roll 2 and abuts the applicator roll 2. The nip surface portion between the rod 4 and the applicator roll 2 is supplied with a coating liquid through a supply nozzle 3a disposed below the nip surface portion. The coating liquid supplied from the supply nozzle 3a is passed through the nip surface portion between the rod 4 and the applicator roll 2 by rotation of the applicator roll 2 and forms a film of coating liquid on the surface of the applicator roll 2. The coating-liquid film on the applicator roll 2 is carried to the nip surface portion between the applicator rolls 2 and 2. The coating-liquid film carried to the nip surface portion is transferred from the applicator rolls 2, 2 onto both surfaces of the base paper 1. In this manner, coated paper is manufactured.

In the above-mentioned coating apparatus, the rod 4 is employed to control the thickness of a film of coating liquid that is formed on the applicator roll 2. The thickness of the coating-liquid film is adjusted by the pressing force of the rod 4 against the applicator roll 2. If the pressing force becomes greater, the thickness of the coating-liquid film will become thinner. The pressing force of the rod 4 against the applicator roll 2 is controlled by the quantity of air within an air tube 6 disposed behind a rod holder 7 that holds the rod 4.

The outer peripheral surface of the rod 4 is cylindrical in shape and is supported by the rod holder 7 so that it is free to rotate. Within the rod holder 7, the rod 4 is slowly rotated in the reversed direction at low speed (about 30 to 60 revolution/min) with respect to the applicator roll 2. In this way, dust and cohesion in the coating liquid is prevented from being caught at the nip surface portion between the rod 4 and the applicator roll 2. FIGS. 6A, 6B, 7A and 7B show conventional rods 4, respectively. In the rod 4 shown in FIGS. 6A and 6B, a plated layer 4a of about 20 μm is formed on the surface of a stainless solid rod 4b of about 12 to 35 mm in diameter (whose length is about a few meters to a few ten meters according to paper width). In the rod 4 shown in FIGS. 7A and 7B, on the other hand, a plated layer 4a of about 20 μm is formed on the surface of a stainless hollow tube 4c of about 12 to 35 mm in diameter. In both rods 4, the plated layer 4a is formed by plating chromium.

The above-mentioned rod metaling type coating apparatus has the following advantages: strong stress is not exerted on base paper, as is done in the blade type; the frequency of cutting in relatively low basis wight paper can be reduced; and even in the case of fine coating, the permeation of a coating liquid into base paper is minimized and therefore coating paper with a good coverage can be manufactured.

On the other hand, the conventional rod metaling type coating apparatus, as shown in FIG. 8, has the problem that at the outlet side of the nip surface portion between the rod 4 and the applicator roll 2, uneven streaks in cross direction may develop on a film of coating liquid formed on the applicator roll surface. These streaks result from a fluctuation in the film thickness. A number of streaks occur at fine pitches of 0.5 to 2 mm over the entire region of the applicator roll 2 in the axial or lateral direction. Particularly, when a film of coating liquid is thick, the circumferential streaks become apparent. The cause of streaks occurring on a film of coating liquid is considered to be for the following reasons. That is, at the outlet side of the nip surface portion between the rod 4 and the applicator roll 2, a coating liquid is not smoothly released from the rod surface and therefore the behavior of the coating liquid on the outlet side of the nip surface portion becomes unstable and uneven.

When a film of coating liquid having the aforementioned circumferential streaks is transferred from the applicator roll 2 onto the base paper 1, the finishing of manufactured coated paper is not satisfactory and the coated paper looks as if it has streaks on the surface. Particularly, in the case of large film thickness, the streaks develop conspicuously on the surface and the quality of the coated paper as a finished product is considerably reduced.

### DISCLOSURE OF THE INVENTION

The present invention has been made in view of the circumstances described above. Accordingly, it is the primary object of the present invention to manufacture coated paper of high quality by restraining streaks from occurring at a film of coating liquid on a roll surface.

To achieve this end, in the present invention, a coating layer having the property of releasing a coated liquid is formed on the outer peripheral surface of a cylindrical rod. This rod is disposed parallel to a first roll that contacts with base paper traveling continuously, directly or through a second roller. The rod is engaged with the first roll and is rotated in a predetermined direction. Next, a coating liquid is supplied to a nip surface portion between the first roll and the rod in the predetermined direction by coating-liquid supply means, and a film of coating liquid is formed on the outer peripheral surface of the first roll. After the thickness of the coating-liquid film is adjusted at the nip surface portion, the thickness-adjusted film is transferred from the first roll onto a surface of the base paper directly, or indirectly through the second roll.

The expression “having the property of releasing a coated liquid” in the present invention is intended to mean having water repellency and also having a non-adhesive property with respect to the binder or co-binder component in the coating liquid. It is preferable that a material for the coating layer employs silicon resin or fluorine-contained resin. Further, a plating layer with the property of releasing a coating liquid can be utilized as the coating layer. The coating layer of the present invention does not exclude the use of plating. Any plating layer, in addition to the above-mentioned resins, with the coating-liquid-releasing property can be used as the coating layer. For example, a polyfluoroethylene dispersed plating layer can be used as such a plating layer. If the coating layer having the property of releasing the coating liquid is formed on the outer peripheral surface of the rod in the aforementioned manner, there is no possibility that the coating liquid will adhere to the rod surface. As a result, the coating liquid is easily released from the rod, and the behavior of the coating liquid on the outlet side of the nip surface portion becomes extremely stable and uniform.

It is also preferable that after fine unevenness is formed on the outer peripheral surface of the rod by surface treatment, the coating layer be formed. With the surface treatment, the coating layer is formed stably on the outer peripheral surface of the rod. As the surface treatment method, fine unevenness can be formed by melting and jetting out ceramic material to the rod surface, or by roughing the outer peripheral surface of the rod with a blasting method. It is preferable that the coating layer be made thin and that it be about 5 μm. However, in the case where wear on the coating layer is taken into consideration, it may be 5 μm or greater. It can also be set within a range of up to 5 mm according to wear on the coating layer.

It is preferred that a rod holder for supporting the rod is constructed as follows. The holder is disposed parallel to the fist roll, and has a supporting hole into which the rod is fitted via a lubricating liquid so as to be supported rotatably. The supporting hole has an opening confronting the surface of the first roll, through which opening part of the outer surface of the rod, thus fitted in the supporting hole, is exposed. On the other side of the rod holder, the side opposite to the side on which the rod-supporting hole is provided, a recess is formed, and a tube whose expansion can be controlled is disposed in the recess. Between the recess and the supporting hole, the holder is constricted. With this arrangement, by controlling the expansion of the tube, it is possible to adjust the bending of the constricted part about the axis of the rod, and it is also possible to adjust the degree that the opening of the supporting hole is opened or closed. This adjustment can prevent the lubricating liquid from leaking from the space between the rod and the supporting hole.

### BRIEF DESCRIPTION OF THE DRAWINGS

The present invention will be described in further detail with reference to the accompanying drawings wherein:

FIG. 1 is a schematic diagram showing the essential part of a coating apparatus constructed according to a preferred embodiment of the present invention;

FIG. 2 is an enlarged sectional view of the rod surface of the coating apparatus shown in FIG. 1;

FIG. 3 is a diagram (photograph) showing the state of a film of coating liquid formed on the applicator roll surface of the coating apparatus shown in FIG. 1;

FIG. 4 is a diagram (photograph) showing the state of a film of coating liquid formed on the applicator roll surface of a conventional coating apparatus;

FIG. 5 is a schematic diagram showing the construction of a conventional rod metaling type coating apparatus;

FIG. 6A is a axial sectional view showing the structure of a rod employed in the conventional coating apparatus;

FIG. 6B is a cross sectional view of the rod shown in FIG. 6A;

FIG. 7A is a axial sectional view showing the structure of another rod employed in the conventional coating apparatus;

FIG. 7B is a cross sectional view of the rod shown in FIG. 7A; and

FIG. 8 is a perspective view used to explain a problem associated with the conventional coating apparatus.

### BEST MODE FOR CARRYING OUT THE INVENTION

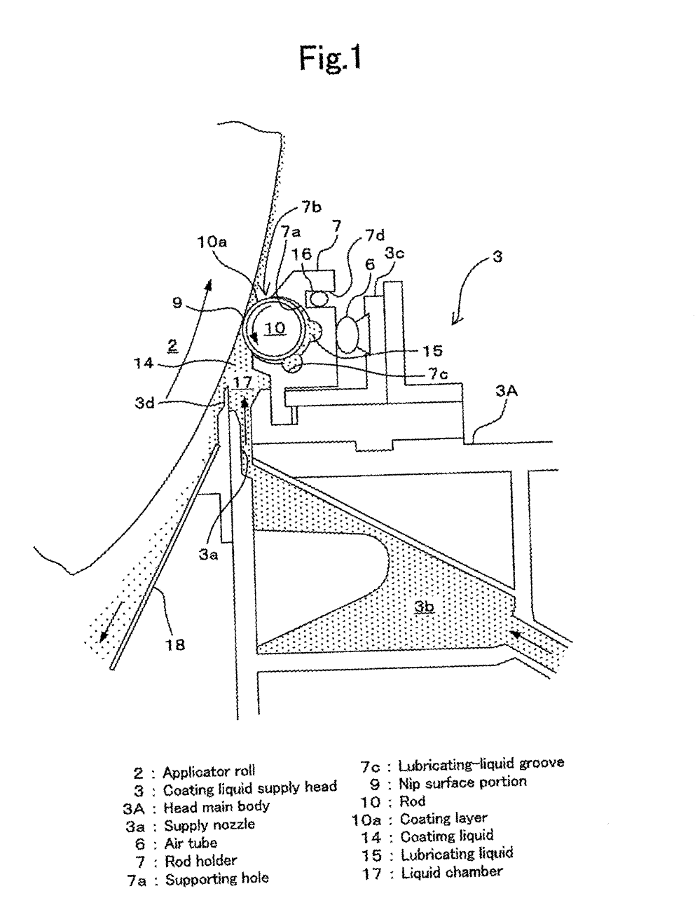

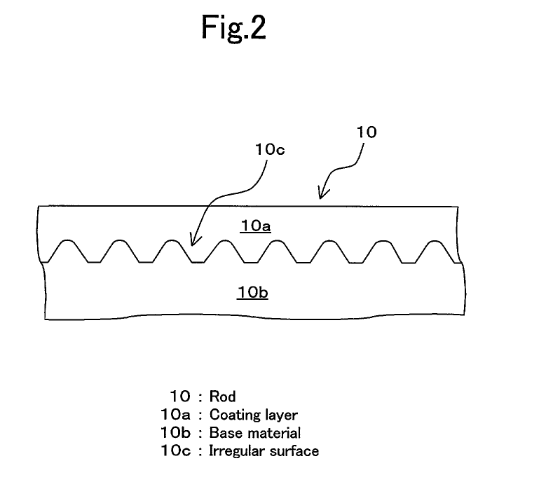

A preferred embodiment of the present invention will hereinafter be described with reference to FIGS. 1 and 2. Note in these figures that the same reference numerals are applied to the same parts as those of the conventional coating apparatus described above.

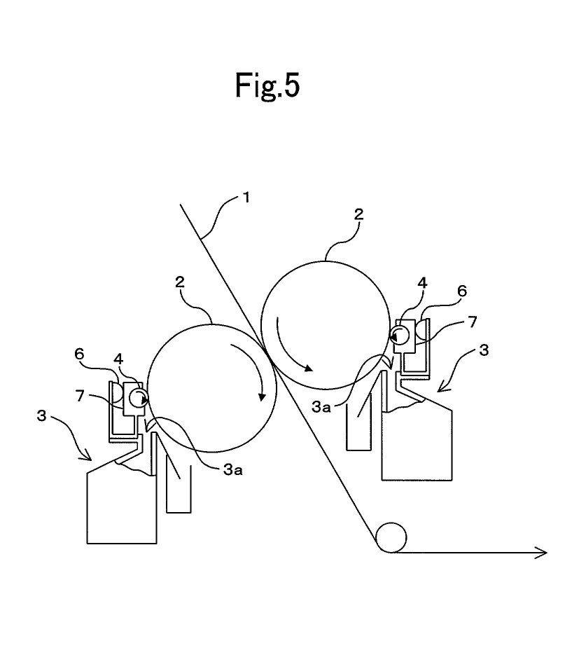

The basic construction of the coating apparatus of the preferred embodiment is the same as the conventional coating apparatus (see FIG. 5). Therefore, the coating apparatus of the preferred embodiment is equipped with a pair of applicator rolls (first rolls) that rotate synchronously across a conveying line for base paper that travels continuously. The base paper is sent out in one direction, while being gripped at the nip surface portion between the applicator rolls. A coating liquid is supplied from a liquid supply head provided near each applicator roll, to the surface of each applicator roll. A film of coating liquid on each applicator roll is transferred at the nip surface portion onto each surface of the base paper.

In the preferred embodiment, the peripheral construction of a rod that is the essential part of the coating apparatus will be described in detail with reference to FIG. 1.

As shown in the figure, the coating apparatus of the preferred embodiment is equipped with a liquid supply head (coating-liquid supply means) 3, which is disposed near an applicator roll 2. More specifically, the liquid supply head 3 is disposed near the side of the applicator roll 2 where the peripheral surface thereof rotates upward. The liquid supply head 3 is equipped at its upper portion with a hollow or solid cylindrical rod 10, which has an outer peripheral surface parallel to the applicator roll 2. This rod 10 is nip-engaged with the peripheral surface of the applicator roll 2. At the nip surface portion 9 between the rod 10 and the applicator roll 2, the rod 10 rotates slowly at a rotational speed of about 30 to 60 revolution per minute in the direction (indicated by an arrow in FIG. 1) opposite to the direction of rotation of the applicator roll 2. The liquid supply head 3 supplies a coating liquid 14 toward the nip surface portion 9 from below, that is, from the upstream side of the rotating direction of the applicator roll 2.

For the rod 10 of the coating apparatus in the preferred embodiment, as shown in FIG. 2, surface treatment is performed on a base material 10b consisting of a stainless rod, and a coating layer 10a, which consists of material having the property of releasing the coating liquid 14, is formed on the surface with fine unevenness 11c, formed by the surface treatment. The material having the property of releasing the coating liquid 14 refers to such a material that can release the coating liquid 14 immediately even if it adheres, that is, a material that has water repellency and also has a non-adhesive property with respect to the binder or co-binder component in the coating liquid 14. More specifically, silicon resin, fluorine-contained resin, etc., can be employed. The surface treatment is the treatment of making a surface uneven so that the coating layer 10a can be easily formed on the base material 10b. More specifically, the unevenness 11c can be formed by roughing the surface of the base material 10b with a blasting method, or by melting and jetting out ceramic material (e.g. alumina grains) to the base material 10b. Note that the irregular surface 10c shown in FIG. 2 is formed by the blasting method. It is preferable that the coating layer 10a be about 5 μm in thickness. However, since the coating liquid 14 contains a large quantity of calcium carbonate that acts as a polishing agent, the coating layer 10a may be easily worn away. Therefore, the thickness of the coating layer 10a may be increased up to about 5 mm in consideration of wear. Note that the hardness of the coating layer 10a can be set within a range of JIS 20 to 70°, however, in case of resin coating or plating, its hardness should be much higher.

A description will be given of the construction of the liquid supply head 3. A rod holder 7 is mounted on the main body 3A of the liquid supply head 3. The rod 10 is supported within a cylindrical-supporting hole 7a formed in the rod holder 7 and is free to rotate. The supporting hole 7a of the rod 10 extends parallel to the applicator roll 2. An opening 7b is formed across the side surface of the rod holder 7 that faces the applicator roll 2. A portion of the periphery of the rod projects out from the opening 7a and nip-engages with the periphery of the applicator roll 2. In addition, the rod 10 supported within the supporting hole 7a is driven by rotation-drive means (not shown), and as described above, it rotates slowly.

The supporting hole 7a is slightly greater in diameter than the rod 10, and the inner peripheral surface of the supporting hole 7a is provided with a plurality of lubricating-liquid grooves 7c extending across the rod holder 7. The lubricating-liquid grooves 7c are supplied with a lubricating liquid 15 by supply means (not shown). Between the supporting hole 7a and the rod 10, a film of lubricating liquid is formed, whereby the lubrication therebetween is assured. A recess 7d is formed in the upper end portion of the rod holder 7 opposite to the supporting hole 7a and extends toward the supporting hole 7a across the rod holder 7. Thus, the rod holder 7 is deformed or bent between the supporting hole 7a and the recess 7d. A seal tube 16 is fitted in the recess 7d. With this arrangement, the rod holder 7 can be deformed on the constricted portion by controlling the quantity of air pressure that is supplied to the seal tube 16. That is, the degree that the opening 7b of the supporting hole 7a is opened or closed is adjusted. This adjustment can prevent the lubricating liquid 15 from leaking from the space between the rod 10 and the supporting hole 7a.

An air tube 6 is interposed between the rod holder 7 and a supporting wall 3c mounted on the head main body 3A. The air tube 6 is filled with air, and is expanded or contracted by a change in the air pressure to adjust the degree that the rod 10 is pressed against the applicator roll 2. The film thickness of a film of coating liquid 14 that is formed on the surface of the applicator roll 2 is determined by the degree that the rod 10 is pressed against the applicator roll 2. Therefore, the film thickness of the coating-liquid film can be controlled by adjusting the air pressure within the air tube 6.

The supply of the coating liquid 14 to the nip surface portion 9 between the rod 10 and the applicator roll 2 is performed by a supply nozzle 3a, which is disposed below the nip surface portion 9 and directed toward the nip surface portion 9. Within the head main body 3A of the supply head 3, a passage 3b is formed to supply the coating liquid 14, the supply nozzle 3a being formed in the outlet end of this interior passage 3b. The supply nozzle 3a is formed into the shape of a slit across the machine so that it can uniformly supply the coating liquid 14 toward the nip surface portion 9. On the inlet side of the nip surface portion 9, a liquid chamber 17 is formed by the applicator roll 2, the rod 10, the rod holder 7, and the partition wall 3d of the head main body 3A. The liquid chamber 17 is filled up with the coating liquid 14 supplied from the supply nozzle 3a. Part of the coating liquid 14 in the liquid chamber 17 is passed through the nip surface portion 9 and forms thin liquid film on the applicator roll 2. At the upper end of the baffle plate wall 3d and on the side of the baffle plate 3d opposite to the liquid chamber 17, there is provided a guide 18 extending downward in an oblique direction. The surplus coating liquid 14 flows down along the guide 18 and is collected.

Next, a description will be made of the operation and advantages of the coating apparatus constructed as described above.

The coating liquid 14, supplied from a pump (not shown) to the liquid supply head 3, passes through the interior passage 3b formed within the head main body 3A and is jetted out toward the nip surface portion 9 between the rod 10 and the applicator roll 2. The coating liquid 14 is flows to the liquid chamber 17 between the supply nozzle 3a and the nip surface portion 9. Part of the coating liquid 14 flows to the liquid chamber 17 is passed through the nip surface portion 9 by rotation of the applicator roll 2. When this is occurring, the quantity that the coating liquid 14 is passed through the nip surface portion 9 is adjusted by the degree that the rod 10 is pressed against the applicator roll 2. In this manner, the film thickness of a film of coating liquid that is formed on the surface of the applicator roll 2 is adjusted at the outlet side of the nip surface portion 9. In addition, since the rod 10 is rotated at the nip surface portion 9 in the direction opposite to the applicator roll 2, dust and cohesions in the coating liquid 14 is prevented from being caught at the nip surface portion 9 between the applicator roll 2 and the rod 10.

Furthermore, in the coating apparatus of the preferred embodiment, the coating layer 10a, which consists of material having the property of releasing the coating liquid 14, is provided on the surface of the rod 10. Therefore, there is no possibility that the coating liquid 14 will adhere to the rod 10 at the outlet side of the nip surface portion 9, and the coating liquid 14 is released in uniform and stably from the rod 10. Thus, according to the coating apparatus of the preferred embodiment, the behavior of the coating liquid 14 on the outlet side of the nip surface portion 9 becomes extremely stable, and even in the case where the film of coating liquid is thick, the occurrence of streaks at the coating-liquid film on the applicator roll 2 can be eliminated.

At the nip surface portion between the right and left applicator rolls 2 and 2, the coating-liquid films formed on the surfaces of right and left applicator rolls 2, 2 are transferred onto both surfaces of base paper being continuously traveled, whereby coated paper is manufactured. According to the coating apparatus of the preferred embodiment, streaks can be eliminated from occurring on a film of coating liquid that is transferred as described above. Therefore, coated paper that is manufactured can be prevented from looking as if it has streaks on the surface. That is, coated paper of high quality can be manufactured by manufacturing coated paper with the coating apparatus of the preferred embodiment.

While the present invention has been described with reference to the preferred embodiment thereof, the invention is not to be limited to the details given herein, but may be modified within the scope of the invention hereinafter claimed. For example, in the preferred embodiment, surface treatment is performed on a stainless rod and the coating layer 10a is formed on the surface-treated rod. However, the surface treatment is dispensable to the present invention. The base material 10b of the rod 10 is not limited to stainless material, but may employ various materials such as an aluminum alloy, etc.

In the preferred embodiment, silicon resin or fluorine-contained resin can be used as a material for the coating layer 10a having the property of releasing the coating liquid 14. However, a material for the coating layer 10a is not limited to silicon resin and fluorine-contained resin. The present invention can employ any material, if it has the property of releasing the coating liquid 14, that is, has water repellency and also has a low-adhesive property with respect to the binder and co-binder component in the coating liquid 14.

In the preferred embodiment, the coating liquid 14 is supplied from the liquid supply head 3 directly to the applicator roll 2. The present invention may be equipped with a metaling roll (second roll), which nip-engages with the applicator roll 2 and rotates in the direction opposite to the applicator roll 2. In this case, the coating liquid 14 is supplied from the liquid supply head 3 to the metaling roll, and the metaling roll becomes the aforementioned first roll.

Furthermore, in the preferred embodiment, the rod 10 is rotated in the direction opposite to the applicator roll 2. However, the rod 10 may be rotated in the same direction as the applicator roll 2.

The present invention will be described in further detail with reference to a comparative example, a first example, and a second example.

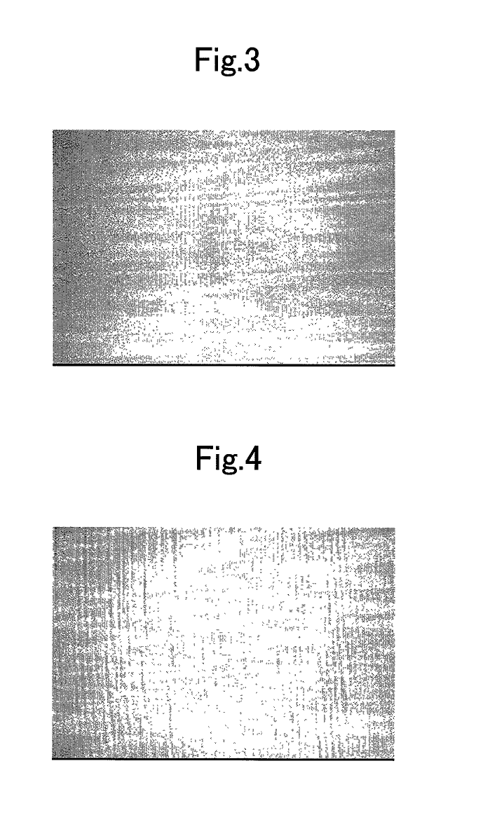

The coating apparatuses, employed in the comparative example, the first example, and the second example, were operated according to their conditions and were estimated by visually observing how streaks developed on the applicator roll surface. FIG. 3 shows the state of a film of coating liquid formed on the applicator roll surface by employing the rod of the present invention, and FIG. 4 shows the state of a film of coating liquid formed on the applicator roll surface by employing the rod of the aforementioned conventional coating apparatus.

### COMPARATIVE EXAMPLE

In the comparative example, tests were made by employing the aforementioned conventional coating apparatus.

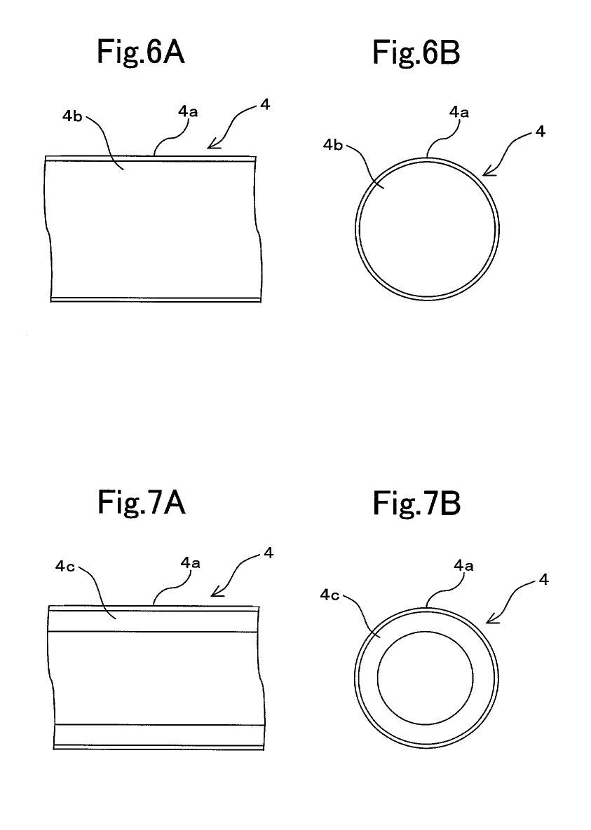

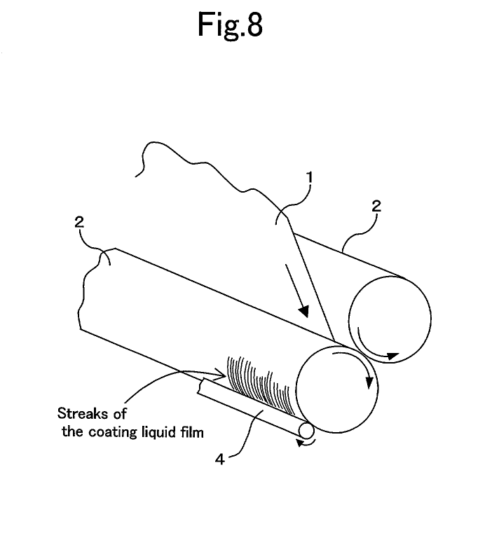

For the rod of the coating apparatus in the comparative example, a common stainless rod plated with chromium (see FIG. 6) were employed. The rotational speed of the applicator roll (traveling speed of base paper) was set at 600 m/min and the film thickness of the coating liquid that is transferred onto base paper was set at 8 μm, 14 μm, 18 μm, and 24 μm.

As listed in Table 1, in the case of a relatively thin film thickness of 8 μm, conspicuous streaks were not observed at the coating-liquid film on the applicator roll surface (estimation ◯). However, in the case of a film thickness of 14 μm, streaks became conspicuous (estimation Δ). In the case of a film thickness of 18 μm, a great number of streaks developed at the coating-liquid film on the applicator roll surface (estimation X), and in the case of a film thickness of 24 μm, an infinite number of streaks developed (estimation XX). The state of the coating-liquid film on the applicator roll surface is shown in FIG. 4. It can be observed from FIG. 4 that number of streaks have developed at the coating-liquid film on the applicator roll surface.

### FIRST EXAMPLE

In the first example, tests were made by employing the coating apparatus of the preferred embodiment shown in FIGS. 1 and 2.

The rod of the coating apparatus in the first example was made by blasting a conventional rod to remove chromium from the surface and to form fine unevenness on the surface, and then coating the surface-treated rod with silicon resin. The rotational speed of the applicator roll was set at 600 m/min and the film thickness of the coating liquid that is transferred onto base paper was set at 14 μm, 19 μm, and 25 μm.

As listed in Table 1, in the case of a film thickness of 14 μm and a film thickness of 19 μm, no streak was observed at the coating-liquid film on the applicator roll surface (estimation ⊚). In the case of a film thickness of 25 μm, conspicuous streaks were not observed at the coating-liquid film on the applicator roll surface (estimation ◯) The state of the coating-liquid film on the applicator roll surface is shown in FIG. 3. It can be observed from FIG. 3 that conspicuous streaks have not developed at all. Thus, according to the first example, it can be ascertained that even in the case where a film of coating-liquid is very thick (25 μm), coated paper of high quality having no streak on the surface can be manufactured.

### SECOND EXAMPLE

In the second example, as with the first example, tests were made by employing the coating apparatus of the preferred embodiment shown in FIGS. 1 and 2.

The rod of the coating apparatus in the second example was made by melting and jetting out ceramic material to the surface of a stainless base material and then coating the surface with silicon resin. The rotational speed of the applicator roll was set at 600 m/min and the film thickness of the coating liquid that is transferred onto base paper was set at 18 μm and 24 μm.

As listed in Table 1, in the case of a film thickness of 18 μm, conspicuous streaks were not observed at the coating-liquid film on the applicator roll surface (estimation ◯). In the case of a film thickness of 24 μm, a great number of streaks were observed at the coated-liquid film on the applicator roll surface (estimation X). However, in the case of a film thickness of 24 μm, the number of streaks are reduced, compared with the case of the film thickness 24 μm in the comparative example. In addition, in the comparative example, conspicuous streaks were observed when the film thickness was 18 μm. However, in the second example, conspicuous streaks were not observed. Thus, according to the second example, it can be ascertained that even when a coating-liquid film is thicker than the comparative example, streaks do not develop.

TABLE 1

| | Speed | Transferred film | |
|---|---|---|---|
| Rod type | (m/min) | thickness (μm) | Estimation |
| Chrome | 600 | 24 | XX |
| plating | | 18 | X |
| (standard) | | 14 | Δ |
| | | 8 | ◯ |
| Silicon | 600 | 25 | ◯ |
| resin | | 19 | ⊚ |
| (blasted | | 14 | ⊚ |
| base) | | | |
| Silicon | 600 | 24 | X |
| resin | | 18 | ◯ |
| (ceramic | | | |
| base) | | | |

From the comparative example, the first example, and the second example, it can be ascertained that by applying the present invention to the manufacture of coated paper, coated paper of high quality having no streak can be manufactured even when a film of coating liquid is thick.

1. A coating apparatus comprising:
a first roll that contacts with base paper traveling continuously, directly or through a second roll;
a cylindrical rod with an outer peripheral surface which is disposed parallel to said first roll and also engages with said first roll and rotates in a predetermined direction;
a coating layer, formed on the outer peripheral surface of said rod, which has the property of releasing a coating liquid; and
coating-liquid supply means for supplying said coating liquid to a nip surface portion between said first roll and said rod in said predetermined direction;
wherein said coating liquid supplied from said coating-liquid supply means forms a film of coating liquid on the outer peripheral surface of said first roll, and after a thickness of said coating-liquid film is adjusted at said nip surface portion, the thickness-adjusted film is transferred from said first roll onto a surface of said base paper directly, or indirectly through said second roll.

2. The coating apparatus as set forth in claim 1, wherein said coating layer is formed from silicon resin.

3. The coating apparatus as set forth in claim 1, wherein said coating layer is formed from fluorine-contained resin.

4. The coating apparatus as set forth in claim 1, wherein said coating layer is a plating layer which has the property of releasing a coating liquid.

5. The coating apparatus as set forth in claim 1, wherein the outer peripheral surface of said rod has fine unevenness on which said coating layer is formed.

6. The coating apparatus as set forth in claim 1, further comprising a rod holder, disposed parallel to said fist roll, for supporting said cylindrical rod, said rod holder having:
a supporting hole in which said cylindrical rod is rotatably fitted via a lubricating liquid, said supporting hole having an opening confronting the outer surface of said applicator roll, through which opening part of the outer surface of said cylindrical rod, which is being fitted in said rod holder, is exposed;
a recess which is formed on a side of said rod holder opposite to the side on which said supporting hole 7a is provided, said rod holder being constricted between said supporting hole 7a and said recess 7d; and
a tube fitted in said recess, said tube being adapted to be controlled in expansion.

7. A method of manufacturing coated paper, comprising the steps of:
forming a coating layer, which has the property of releasing a coated liquid, on an outer peripheral surface of a cylindrical rod;
disposing said rod in parallel with a first roll, then engaging said rod with said first roll, and rotating said rod in a predetermined direction;
supplying said coating liquid to a nip surface portion between said first roll and said rod in said predetermined direction;
forming a film of coating liquid on the outer peripheral surface of said first roll, and then adjusting a thickness of said coating-liquid film at said nip surface portion; and
transferring the thickness-adjusted film from said first roll onto a surface of said base paper directly, or indirectly through said second roll.

8. A coating apparatus, comprising:
a first roll that contacts with base paper traveling continuously, directly or through a second roll;
a cylindrical rod with an outer peripheral surface, disposed parallel to said first roll to engage with said first roll, said cylindrical rod being supported by a rod holder in such a way that said cylindrical rod can rotate in a predetermined direction; and
coating-liquid supply means for supplying said coating liquid to a nip surface portion between said first roll and said rod in said predetermined direction,
wherein said coating liquid supplied from said coating-liquid supply means forms a film of coating liquid on the outer peripheral surface of said first roll, and after a thickness of said coating-liquid film is adjusted at said nip surface portion, the thickness-adjusted film is transferred from said first roll onto a surface of said base paper directly, or indirectly through said second roll, and
wherein said rod holder, disposed parallel to said fist roll, for supporting said cylindrical rod has:
a supporting hole in which said cylindrical rod is rotatably fitted via a lubricating liquid, said supporting hole having an opening confronting the outer surface of said applicator roll, through which opening part of the outer surface of said cylindrical rod, which is being fitted in said rod holder, is exposed;
a recess which is formed on a side of said rod holder opposite to the side on which said supporting hole 7a is provided, said rod holder being constricted between said supporting hole 7a and said recess 7d; and
a tube fitted in said recess, said tube being adapted to be controlled in expansion.
